(19) United States
(12) Patent Application Publication
(10) Pub. No.: US 2008/0246615 A1
(43) Pub. Date: Oct. 9, 2008

(54) RFID antenna cupped reflector

(75) Inventors: Mark Duron, East Patchogue, NY (US); Richard T. Knadle, Dix Hills, NY (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/730,865

(22) Filed: Apr. 4, 2007

(51) Int. Cl. G08B 13/14

(52) U.S. Cl. 340/572.7

(57) ABSTRACT

Methods, systems, and apparatuses for radio frequency identification (RFID) reader antennas are described. In as aspect, a reader antenna includes a reflecting element and a radiating element. The reflecting element has a body that defines a cavity. The radiating element is positioned in the cavity. The radiating element transmits a RF signal for the reader antenna. The reflecting element reflects the RF signal to alter a characteristic of the RF signal transmitted by the reader antenna.

### BACKGROUND OF THE INVENTION

1. Field of the Invention

The present invention relates to wireless communications, and more particularly, to radio frequency identification (RFID) RFID readers that communicate with RFID tags.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Since the reader “interrogates” RFID tags, and receives signals back from the tags in response to the interrogation, the reader is sometimes termed as “reader interrogator” or simply “interrogator”.

With the maturation of RFID technology, efficient communications between tags and interrogators has become a key enabler in supply chain management, especially in manufacturing, shipping, and retail industries, as well as in building security installations, healthcare facilities, libraries, airports, warehouses etc.

In a RFID system, typically a reader transmits a continuous wave (CW) or modulated radio frequency (RF) signal to a tag. The tag receives the signal, and responds by modulating the signal, “backscattering” an information signal to the reader. The reader receives signals back from the tag, and the signals are demodulated, decoded and further processed.

What is needed is inexpensive and non-complex ways of increasing transmitted signal ranges for readers. Furthermore, what is needed is ways of increasing range while decreasing an amount of interference between readers operating in the field. Furthermore, what is needed are ways of decreasing an input signal power required by readers.

### BRIEF SUMMARY OF THE INVENTION

Methods, systems, and apparatuses for radio frequency identification (RFID) reader antennas are provided. In an aspect, a reader antenna includes a reflecting element and a radiating element. The reflecting element has a body that defines a cavity. The radiating element is positioned in the cavity. The radiating element transmits a RF signal for the reader antenna. The reflecting element reflects the RF signal to alter a characteristic of the RF signal transmitted by the reader antenna.

In a further aspect, the reflecting element may be cup shaped. In a still further aspect, the reflecting element is configured to be retrofitted to existing reader antennas.

In aspects, the reflecting element alters one or more characteristics of the RF signal transmitted by the reader antenna, including narrowing a transmitted signal pattern, increasing a gain, and/or increasing a range of the RF signal transmitted by the reader antenna.

In a further aspect, the reader antenna includes a second reflecting element. The second reflecting element defines a second cavity. The first reflecting element is positioned in the second cavity. The second reflecting element further alters a characteristic of the RF signal transmitted by the reader antenna. In further aspects, one or more additional reflecting elements may be cascaded with the first and second reflecting elements.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an environment where RFID readers communicate with an exemplary population of RFID tags.

FIG. 2 shows a block diagram of receiver and transmitter portions of an RFID reader.

FIGS. 3 and 4 show front and cross-sectional side views of an example reader antenna.

FIG. 5 shows a mounting bracket coupled to the reader antenna of FIG. 4, according to an example embodiment.

FIGS. 6 and 7 show front and cross-sectional side views of a reader antenna, according to an example embodiment of the present invention.

FIG. 8 shows a flowchart providing example steps for operation of the reader antenna of FIGS. 5, 6 and 7, according to an example embodiment of the present invention.

FIGS. 9-12 show example steps that may be performed during the flowchart of FIG. 8, according to embodiments of the present invention.

FIGS. 13 and 14 show front and cross-sectional side views of a reader antenna, according to an example embodiment of the present invention.

FIGS. 15 and 16 show example radiated signal patterns for reader antennas, according to embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

### Example RFID System Embodiment

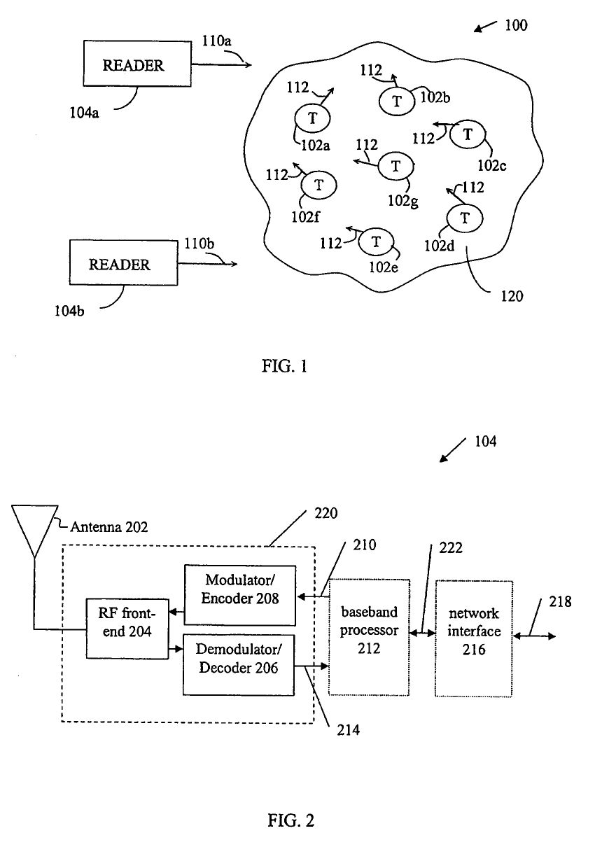

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. A population 120 may include any number of tags 102.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network.

As shown in FIG. 1, reader 104a transmits an interrogation signal 110 having a carrier frequency to the population of tags 120. Reader 104b transmits an interrogation signal 110b having a carrier frequency to the population of tags 120. Readers 104a and 104b typically operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency, and/or by phase shifting the reflected signal according to a time-based pattern or frequency. This technique for alternatively absorbing and reflecting signal 110 is referred to herein as backscatter modulation in amplitude and/or phase. Readers 104a and 104b receive and obtain data from response signals 112, such as an identification number of the responding tag 102. In the embodiments described herein, a reader may be capable of communicating with tags 102 according to any suitable communication protocol, including Class 0, Class 1, EPC Gen 2, other binary traversal protocols and slotted aloha protocols, any other protocols mentioned elsewhere herein, and future communication protocols.

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch (sometimes referred to as Micro Strip, or printed circuit) antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FMO or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

Example embodiments of the present invention are described in further detail below. Such embodiments may be implemented in the environments and readers described above, and/or in alternative environments and alternative RFID devices.

### Example Embodiments

Methods, systems, and apparatuses for improved reader antennas are described. In an embodiment, a radiating element of a reader antenna is mounted in a reflecting element. The reflecting element causes the reader antenna to radiate a modified RF signal. The modified RF signal may have various improved attributes, including beam shape, gain, and/or range. These embodiments can be implemented in many types of RFID readers, including those described above and otherwise known.

The example embodiments described herein are provided for illustrative purposes, and are not limiting. The examples described herein may be adapted to any type of tag and reader. Further structural and operational embodiments, including modifications/alterations, will become apparent to persons skilled in the relevant art(s) from the teachings herein.

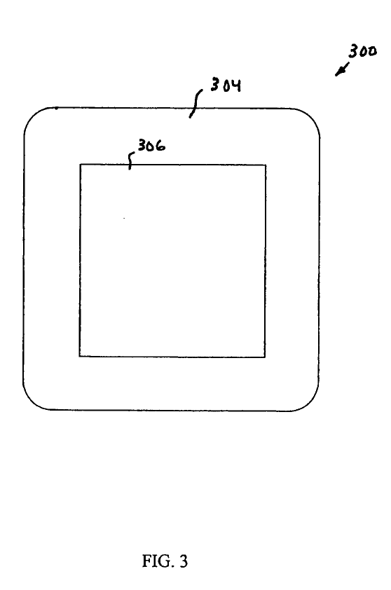

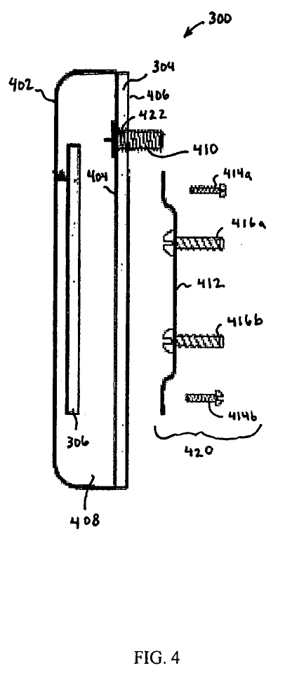

FIG. 3 shows a front view of a reader antenna 300, according to an example embodiment of the present invention. FIG. 4 shows a cross-sectional side view of reader antenna 300. Reader antenna 300 may be a reader antenna similar to those described above, a reader antenna described in U.S. Ser. No. 11/265,143, filed Nov. 3, 2005, titled “Low Return Loss Rugged RFID Antenna,” or a reader antenna otherwise known. As shown in FIG. 3, reader antenna 300 has a substantially rectangular shape, with rounded corners. However, in alternative embodiments, reader antenna 300 may have other shapes, including round or elliptical, elongated, etc.

In FIG. 3, a counterpoise element 304 and a radiating element 306 of reader antenna 300 are shown. FIG. 4 shows reader antenna 300 including counterpoise element 304, radiating element 306, and a radome 402 (radome 402 is not shown in FIG. 3).

As shown in FIG. 4, counterpoise element 304 is planar in shape, and has opposing first and second surfaces 404 and 406. Radome 402 is cup-shaped, and is mounted to first surface 404 of counterpoise element 304 to form an enclosure 408. Radiating element 306 is shown in FIGS. 3 and 4 as a patch-type radiator/antenna. Radiating element 306 can also be referred to as an antenna, a patch antenna, a radiator, a patch radiator, a micro strip antenna, a micro strip element antenna, a printed circuit antenna, etc. However, in alternative embodiments, radiating element 306 may be a type of radiator/antenna other than a patch radiator. As shown in FIG. 4, radiating element 306 is positioned in enclosure 408.

Radiating element 306 can be made of any suitable conducting material, including a metal. Counterpoise element 304 can be made of any suitable material, including a metal. Furthermore, in an embodiment, counterpoise element 304 may be coupled to a ground (or other) electrical potential to operate as a ground plane for reader antenna 300. Radome 402 is configured to protect radiating element 306 from impacts, etc. Radome 402 can be made of any suitable non-conducting material, including a plastic, polymer, etc.

FIG. 4 further shows a RF input signal connector 410. RF input signal connector 410 mounts in a port 422 through counterpoise element 304. An RF input signal is received on RF input signal connector 410, and is coupled to radiating element 306, which radiates the RF input signal. The coupling of RF input signal connector 410 to radiating element 306 is not shown in FIG. 4, but may be accomplished in a variety of ways, as would be known to persons skilled in the relevant art(s), such as by a direct-connection wire, or indirect capacitive connection, an indirect inductive loop connection, or other electrical connection. The RF input signal may be an interrogation signal, such as interrogation signal 110a shown in FIG. 1, or other signal radiated from an antenna of a reader.

FIG. 4 further shows a mounting bracket 412, a first set of attachment members 414a and 414b, and a second set of attachment member 416a and 416b, which form an interface mechanism 420 that can be used to mount reader antenna 300 to a surface/object. First and second sets of attachment members 414 and 416 are shown in FIG. 4 as screws/bolts, but can be any type of attachment mechanism, including nails, screws, bolts, rivets, an adhesive, and/or other mechanism, and can include any number of members.

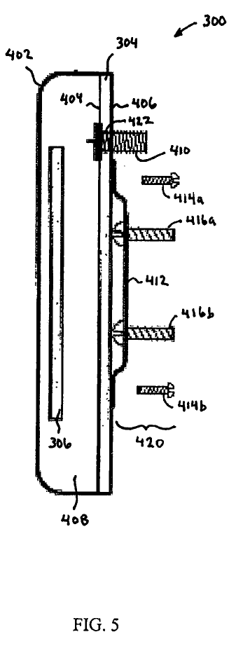

FIG. 5 shows mounting bracket 412 coupled to reader antenna 300, according to an example embodiment. In the example of FIG. 5, attachment members 414, shown as screws, are screwed through mounting bracket 412 into counterpoise element 304 to mount mounting bracket 412 to reader antenna 300. Attachment members 416, also shown as screwed, are screwed through a central portion of mounting bracket 412 in a direction opposite to attachment members 414. The ends of attachment members 416 may be further screwed into a surface/object to which reader antenna 300 is to be mounted.

Note that reader antenna 300 can be configured to radiate linear, elliptical, circular (CW or CCW), and other signal polarizations, at various power levels. In an embodiment, to conform with current FCC requirements, reader antenna 300 may be configured to transmit to a gain limit of 6 dBi linearly polarized (“linear”), or a 9 dBi circularly polarized (“circular”) equivalent.

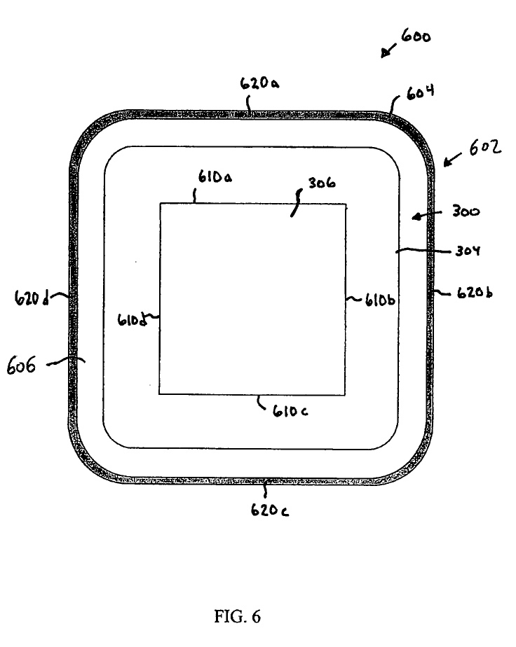

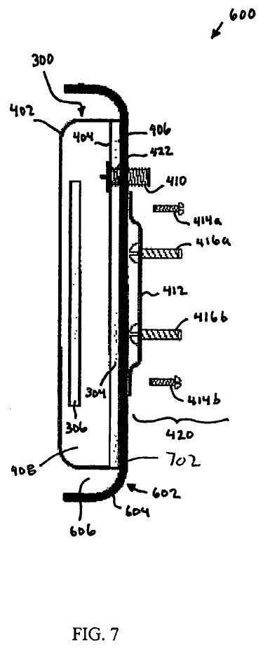

FIG. 6 shows a front view of a RFID reader antenna 600, according to an embodiment of the present invention. FIG. 7 shows a side cross-sectional view of reader antenna 600. As shown in FIG. 6, reader antenna 600 includes reader antenna 300 and a cup-shaped reflecting element 602. As shown in FIG. 7, cup-shaped reflecting element 602 has a cup-shaped body 604 that defines a cavity 606. In alternate embodiments, body 604 may also be circular or round shaped without substantially impacting antenna parameters of reader antenna 600, such as gain and directivity, as would be as would be known to persons skilled in the relevant art(s). Cavity 606 is surrounded by edges 620a-620d of body 604. Radiating element 306 is positioned in cavity 606. Cup-shaped reflecting element 602 reflects the RF signal radiated from radiating element 306, such that a combined RF signal radiated from reader antenna 600 has modified properties when compared to a RF signal radiated from reader antenna 300.

In the example of FIG. 7, reader antenna 300 is mounted in cup-shaped reflecting element 602 to form reader antenna 600. In particular, second surface 422 of counterpoise element 304 is coupled to a planar portion of an inner surface 610 of body 604, in cavity 606. RF input signal connector 410 is positioned in a port through body 604 and in port 422 in counterpoise element 304 to extend into enclosure 408 for coupling to radiating element 306.

Reader antenna 600 may be mounted to surfaces/objects using a variety of mounting configurations, including standard mounting structures. For example, interface mechanism 420 for reader antenna 300 may be adapted to mount reader antenna 600. As shown in FIG. 7, mounting bracket 412 is coupled an outer surface 702 of body 604, external to cavity 606. In the example of FIG. 7, attachment members 414, shown as screws, are screwed first through mounting bracket 412, next through body 604 of cup-shaped reflecting element 602, and finally into counterpoise element 304. In this manner, attachment members 414 fasten mounting bracket 412 to reader antenna 600, and attachment members 416 can be used to fasten reader antenna 600 to a surface/object via mounting bracket 412. Note that other mounting mechanisms may be used to mount reader antenna 600, as would be known to persons skilled in the relevant art(s).

Cup-shaped reflecting element 602 is shown in FIGS. 6 and 7 as having a substantially rectangular (e.g., square) shape, with rounded corners. However, in alternative embodiments, cup-shaped reflecting element 602 may have other shapes, including round or elliptical, etc. Furthermore, cup-shaped reflecting element 602 may have holes or openings through body 604, notches formed in one or more of edges 620a-620d of body 604, a uniform or varying thickness, and/or further variation in characteristics in order to tune, strengthen, enhance mounting, or otherwise enhance cup-shaped reflecting element 602, depending on the particular application. Cup-shaped reflecting element 602 can be made of any suitable electrical conducting material, including a metal. Note that cup-shaped reflecting element 602 can be retrofitted to suitable existing reader antennas, and thus installation can be relatively simple, with little to no modification of the existing reader antennas required.

FIG. 7 shows radome 402 mounted to first surface 404 of counterpoise element 304 to form an enclosure 408. In alternate embodiments, radome 402 may also be coupled to other portions of reader antenna 600 such as body 604.

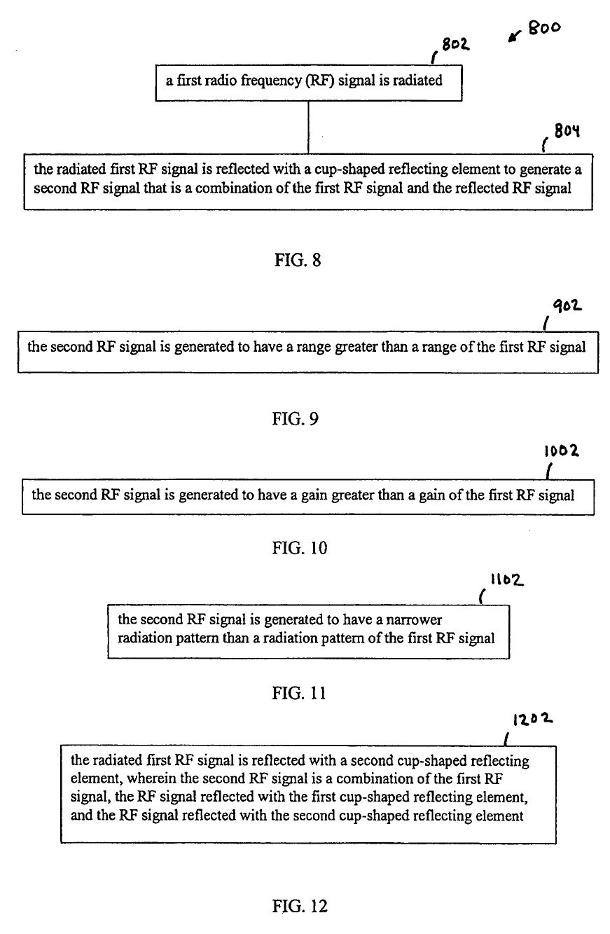

FIG. 8 shows a flowchart 800 providing example steps for operation of reader antenna 600, according to an example embodiment of the present invention. Other structural and operational embodiments will be apparent to persons skilled in the relevant art(s) based on the following discussion. The steps of flowchart 800 are described in detail below.

Flowchart 800 begins with step 802. In step 802, a first radio frequency (RF) signal is radiated. For example, in an embodiment, radiating element 306 transmits a RF signal to tags, such as a signal to power the tags and/or an interrogation signal (such as interrogation signal 110a of FIG. 1). The RF signal is generally radiated in a direction perpendicular to radiating element 306. In the example of FIG. 5 for reader antenna 300, the RF signal is radiated generally in a leftward direction from radiating element 306 (due to the presence of counterpoise element 304).

In step 804, the radiated first RF signal is reflected with a cup-shaped reflecting element to generate a second RF signal that is a combination of the first RF signal and the reflected RF signal. For example, the cup-shaped reflecting element may be cup-shaped reflecting element 602 shown in FIGS. 6 and 7. In an embodiment, the RF signal is reflected generally in a same direction as the RF signal radiated from radiating element 306. The RF energy generated at the edges of radiating element 306 (shown as edges 610a-610d in FIG. 6) is coupled to the edges of cup-shaped reflecting element 602 (shown as edges 620a-620d in FIG. 6). The RF energy is re-radiated (reflected) from edges 620a-620d of cup-shaped reflecting element 602 to create a co-phase field which reshapes the RF signal radiated by radiating element 306 (the “first RF signal”) into an enhanced RF signal (the “second RF signal”) that is a combination of the first RF signal and RF signal re-radiated from edges 620a-620d.

Radiating element 306 and cup-shaped reflecting element 602 form a phased array. The RF signal radiated from the combination of radiating element 306 and cup-shaped reflecting element 602 may have enhanced characteristics, such as a higher gain and larger aperture, relative to radiating element 306 alone. FIGS. 9-11 show example steps that may be performed during step 804 of flowchart 800. In step 902, the second RF signal is generated to have a range greater than a range of the first RF signal. Thus, for example, in an embodiment, the RF signal radiated from the combination of radiating element 306 and cup-shaped reflecting element 602 has a range greater than a range of a similar input power level signal radiated by radiating element 306 alone.

In step 1002 of FIG. 10, the second RF signal is generated to have a gain greater than a gain of the first RF signal. Thus, for example, in an embodiment, the RF signal radiated from the combination of radiating element 306 and cup-shaped reflecting element 602 has a gain greater than a gain of a similar input power level signal radiated by radiating element 306 alone.

In step 1102 of FIG. 11, the second RF signal is generated to have a narrower radiation pattern than a radiation pattern of the first RF signal. Thus, for example, in an embodiment, the RF signal radiated from the combination of radiating element 306 and cup-shaped reflecting element 602 has a narrower pattern than a pattern of a similar power level signal radiated by radiating element 306 alone.

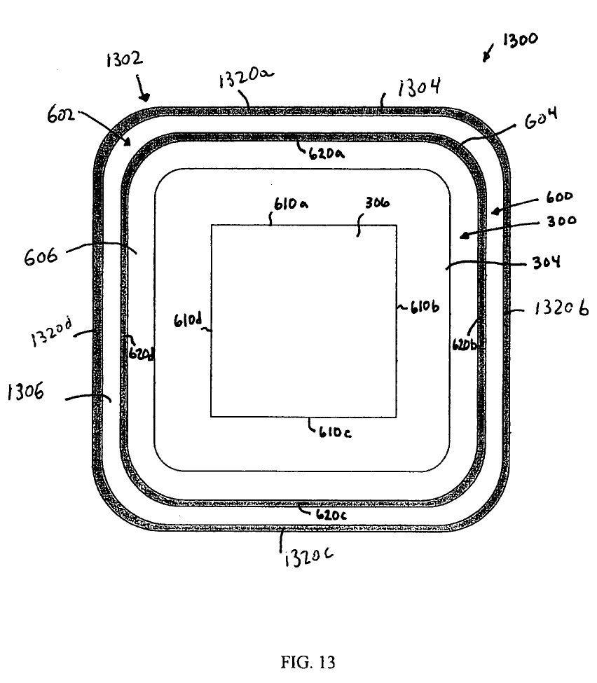

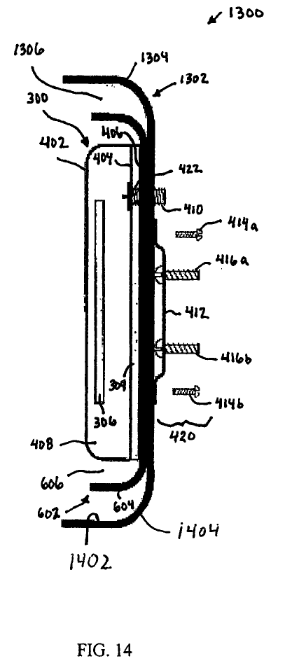

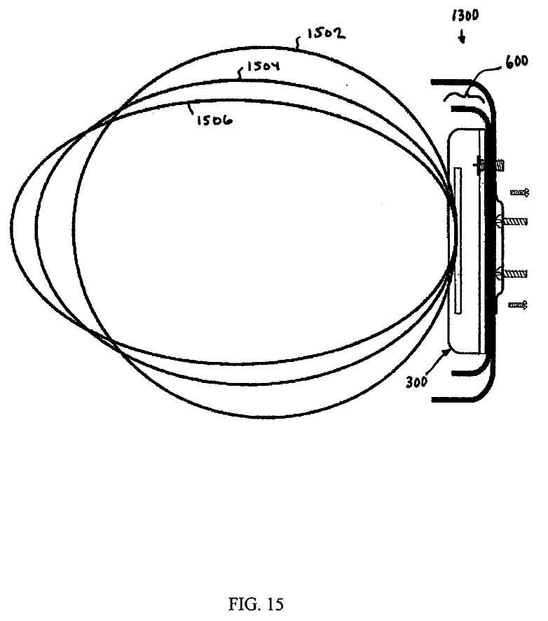

In further embodiments, one or more additional reflecting elements may be cascaded to further enhance characteristics of radiated RF signals. For example, FIG. 13 shows a front view of a RFID reader antenna 1300, according to an embodiment of the present invention. FIG. 14 shows a side cross-sectional view of reader antenna 1300. As shown in FIGS. 13 and 14, reader antenna 1300 includes reader antenna 600 and a second cup-shaped reflecting element 1302. Second cup-shaped reflecting element 1302 may be configured similarly to first cup-shaped reflecting element 602 shown in FIGS. 6 and 7. As shown in FIGS. 13 and 14, second cup-shaped reflecting element 1302 has a cup-shaped body 1304 that defines a cavity 1306. Cavity 1306 is surrounded by edges 1320a-1320d of body 1304. First cup-shaped reflecting element 602 is positioned in cavity 1306. Second cup-shaped reflecting element 1302 reflects the RF signal radiated from radiating element 306, such that a combined RF signal radiated from reader antenna 600 has modified properties when compared to a RF signal radiated from reader antenna 300 alone or reader antenna 600 alone.

In the example of FIGS. 13 and 14, reader antenna 600 is mounted in second cup-shaped reflecting element 1302 to form reader antenna 1300. In particular, outer surface 702 of body 604 of second cup-shaped reflecting element 1302 is coupled to a planar portion of an inner surface 1402 of body 1304, in cavity 1306. RF input signal connector 410 is positioned in a port through body 1304, a port through body 604, and in port 422 in counterpoise element 304 to extend into enclosure 408 for coupling to radiating element 306.

Mounting bracket 412 is coupled to an outer surface 1404 of body 1304, external to cavity 1306. In the example of FIG. 14, attachment members 414, shown as screws, are screwed first through mounting bracket 412, next through body 1304 of second cup-shaped reflecting element 1302, next through body 604 of first cup-shaped reflecting element 602, and finally into counterpoise element 304. In this manner, attachment members 414 fasten mounting bracket 412 to reader antenna 1300, and attachment members 416 can be used to fasten reader antenna 1300 to a surface/object via mounting bracket 412.

Operation of reader antenna 1300 is similar to that of reader antenna 600, with the addition of a second reflected signal. FIG. 12 shows an optional step 1202 that may be performed for flowchart 800 of FIG. 8, in regard to a two-reflecting element embodiment. In step 1202, the radiated first RF signal is reflected with a second cup-shaped reflecting element, wherein the second RF signal (of step 804) is a combination of the first RF signal, the RF signal reflected with the first cup-shaped reflecting element, and the RF signal reflected with the second cup-shaped reflecting element.

In a similar manner as shown in FIGS. 13 and 14 for second cup-shaped reflecting element 1302, a third, a fourth, and/or additional cup-shaped reflecting elements can be incorporated in reader antennas to further enhance transmitted RF signals. Such higher order arrays may experience higher order waveguide modes within the reader antenna structure, which may distort a pattern of a radiated signal. However, mode suppressors may be incorporated into the reader antenna to limit the effects of the higher order modes.

Adding one or more cup-shaped reflecting elements increases a size of an antenna of a reader. Gain correlates to a size of an antenna array. Furthermore, a pattern angle (field of view) of an antenna array is inversely proportional to the square root of gain. Thus, an antenna array grow in size with increasing gain.

FIG. 14 shows radome 402 mounted to first surface 404 of counterpoise element 304 to form an enclosure 408. In alternate embodiments, radome 402 may also be coupled to other portions of reader antenna 1300 such as body 604 or body 1304.

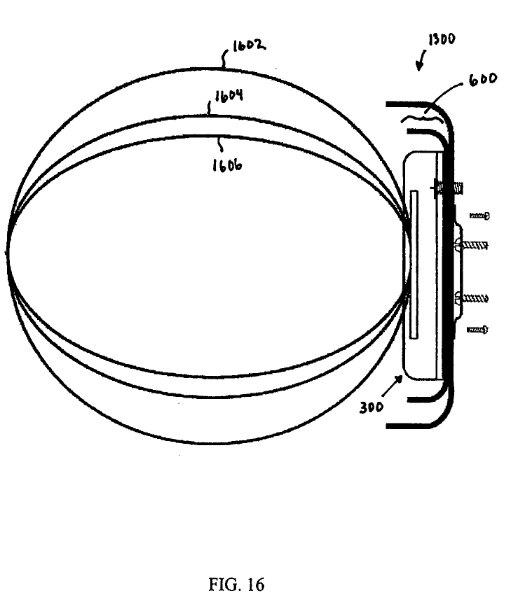

FIGS. 15 and 16 both show example radiated signal patterns for reader antenna 300 of FIG. 5, reader antenna 600 of FIG. 7, and reader antenna 1300 of FIG. 14. FIG. 15 shows a first radiated signal pattern 1502 for reader antenna 300 (no reflectors), a second radiated signal pattern 1504 for reader antenna 600 (a single reflector), and a third radiated signal pattern 1506 for reader antenna 1300 (two reflectors) (reader antenna 1300 is shown in FIG. 15 for illustrative purposes, to show a reader antenna position relative to the signal patterns). The signal patterns of FIG. 15 each represent a loci of a constant gain. As shown in FIG. 15, second radiated signal pattern 1504 for reader antenna 600 has a higher gain and range, and is narrower in 3 dB beam width (from top to bottom in FIG. 15), relative to first radiated signal pattern 1502 for reader antenna 300. Furthermore, third radiated signal pattern 1506 for reader antenna 1300 has a higher gain and range, and is narrower in 3 dB beam width, relative to second radiated signal pattern 1504 for reader antenna 600. For example, first radiated signal pattern 1502 may have a gain of 6 dBi linear (9 dBi circular equivalent), while second radiated signal pattern 1504 has a gain of 8 dBi linear (11 dBi circular equivalent), and while third radiated signal pattern 1506 has a gain of 9 dBi linear (12 dBi circular equivalent). Thus, the addition of one or more reflector elements can be used to increase gain, range, and create a narrower, more focused, signal pattern for a reader antenna.

Furthermore, an input power can be reduced through the use of one or more reflector elements. For example, FIG. 16 shows a first radiated signal pattern 1602 for reader antenna 300 (no reflectors), a second radiated signal pattern 1604 for reader antenna 600 (a single reflector), and a third radiated signal pattern 1606 for reader antenna 1300 (two reflectors) (reader antenna 1300 is shown in FIG. 16 for illustrative purposes, to show a reader antenna position relative to the signal patterns). In the example of FIG. 16, first radiated signal pattern 1602 is a maximum gain of 6 dBi at a maximum RF input power of 1 Watt allowed by the FCC for certain antenna types. First and second radiated signal patterns 1604 and 1606 are shown adjusted (to reduce their excessive EIRP and off bore-sight range) to a common EIRP of 4 Watts. Second radiated pattern 1604 has a RF input power of 0.63 Watts (−2 dB), and third radiated pattern 1606 has a RF input power of 0.5 Watts (−3 dB). Thus, second and third radiated signal patterns 1604 and 1606 can be driven at reduced power levels so as not to exceed a maximum effective radiated power (EIRP), which is equal to linear gain×input power. In this case, for first radiated signal pattern 1602:

4 Watts EIRP=6 dBi (linear gain)×1 Watt (input power)

For second radiated signal pattern 1604:

4 Watts EIRP=8 dBi (linear gain)×0.63 Watt (input power)

For third radiated signal pattern 1606:

4 Watts EIRP=9 dBi (linear gain)×0.5 Watt (input power)

Embodiments that increase antenna gain, while reducing input power back to a same effective EIRP level, have advantages. For example, such a configuration results in a reduced pattern angle. For instance, second radiated signal pattern 1604 is narrower than first radiated signal pattern 1602, and third radiated signal pattern 1606 is narrower than second radiated signal pattern 1604. A narrower pattern angle reduces an amount of undesired reads of tags that may occur in a periphery of the field of view of the reader antenna. Furthermore, less actual power is radiated by the reader antenna having a reflector element. Thus, interference to nearby reader antennas due to the reader antenna having a reflector element is reduced, and the effect of the nearby reader antennas on the reader antenna is reduced. In an embodiment, when a pair of reader antennas are configured with reflector elements to have narrower fields of view, a net effect of an interaction between the two reader antennas is reduced by the square of the reduction in the fields of views of the reader antennas.

### Example Computer System Embodiments

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into a computer system using a removable storage drive, hard drive, or communications interface. The control logic (software), when executed by a processor, causes the processor to perform the functions of the invention as described herein.

According to an example embodiment, a reader may execute computer-readable instructions to transmit a RF signal, as further described elsewhere herein.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A radio frequency identification (RFID) reader antenna, comprising:
a cup-shaped reflecting element having a body that defines a cavity; and
a patch radiating element positioned in the cavity.

2. The RFID reader antenna of claim 1, further comprising:
a second cup-shaped reflecting element that defines a second cavity;
wherein the first cup-shaped reflecting element is positioned in the second cavity.

3. The RFID reader antenna of claim 2, further comprising:
a third cup-shaped reflecting element that defines a third cavity;
wherein the second cup-shaped reflecting element is positioned in the third cavity.

4. The RFID reader antenna of claim 2, further comprising:
at least one additional cup-shaped reflecting element;
wherein the second cup-shaped reflecting element is positioned in a cavity of the at least one additional cup-shaped reflecting element.

5. The RFID reader antenna of claim 1, wherein the body has a substantially rectangular shape.

6. The RFID reader antenna of claim 5, the body has at least one rounded corner.

7. The RFID reader antenna of claim 1, further comprising:
a counterpoise element having opposing first and second surfaces; and
a radome;
wherein the second surface of the counterpoise element is coupled to a surface of the body in the cavity;
wherein said patch radiating element is positioned in an enclosure that includes the radome.

8. The RFID reader antenna of claim 7, further comprising:
a radio frequency (RF) input signal connector;
wherein said counterpoise element has a port that receives RF input signal connector; and
wherein a RF input signal from the RF input signal connector is coupled to the patch radiating element.

9. The RFID reader antenna of claim 7, further comprising:
a mounting bracket coupled to a second surface of the body external to the cavity.

10. The RFID reader antenna of claim 9, further comprising:
a first plurality of attachment members that fasten the mounting bracket to the second surface of the body.

11. The RFID reader antenna of claim 10, further comprising:
a second plurality of attachment members coupled to the mounting bracket;
wherein the second plurality of attachment members are configured to mount the RFID reader antenna to a operating location.

12. The RFID reader antenna of claim 1, wherein the cup-shaped reflecting element is configured to increase a radiating range of the RFID reader antenna relative to a radiating range of the patch radiating element.

13. The RFID reader antenna of claim 1, wherein the cup-shaped reflecting element is configured to increase a gain of the RFID reader antenna relative to a gain of the patch radiating element.

14. The RFID reader antenna of claim 1, wherein the cup-shaped reflecting element is configured to narrow a width of a pattern radiated by the RFID reader antenna relative to a pattern radiated by the patch radiating element.

15. The RFID reader antenna of claim 1, wherein the body has a substantially circular or round shape.

16. A method in a radio frequency identification (RFID) reader antenna, comprising:
radiating a first radio frequency (RF) signal; and
reflecting the radiated first RF signal with a cup-shaped reflecting element to generate a second RF signal that is a combination of the first RF signal and the RF signal reflected with the cup-shaped reflecting element.

17. The method of claim 16, wherein said radiating comprises:
radiating the first radio frequency (RF) signal from a patch radiating element.

18. The method of claim 17, wherein said radiating further comprises:
radiating the first radio frequency (RF) signal from the radiating element positioned in a cavity of the cup-shaped reflecting element.

19. The method of claim 16, further comprising:
reflecting the radiated first RF signal with a second cup-shaped reflecting element, wherein the second RF signal is a combination of the first RF signal, the RF signal reflected with the first cup-shaped reflecting element, and the RF signal reflected with the second cup-shaped reflecting element.

20. The method of claim 16, further comprising:
reflecting the radiated first RF signal with at least one additional cup-shaped reflecting element, wherein the second RF signal is a combination of the first RF signal, the RF signal reflected with the first cup-shaped reflecting element, and the RF signal reflected with the at least one additional cup-shaped reflecting element.

21. The method of claim 16, wherein said reflecting comprises:
generating the second RF signal to have a range greater than a range of the first RF signal.

22. The method of claim 16, wherein said reflecting comprises:
generating the second RF signal to have a gain greater than a gain of the first RF signal.

23. The method of claim 16, wherein said reflecting comprises:
generating the second RF signal to have a narrower radiation pattern than a radiation pattern of the first RF signal.

24. A radio frequency identification (RFID) reader antenna, comprising:
means for radiating a first radio frequency (RF) signal; and
means for reflecting the radiated first RF signal to generate a second RF signal that is a combination of the first RF signal and the reflected RF signal.
